(19) United States
(12) Patent Application Publication
(10) Pub. No.: US 2026/0186211 A1
(43) Pub. Date: Jul. 2, 2026

(54) OPTICAL CONNECTOR

(71) Applicant: Fujikura Ltd., Tokyo (JP)

(72) Inventor: Ryoichi Mitobe, Sakura-shi (JP)

(73) Assignee: Fujikura Ltd., Tokyo (JP)

(21) Appl. No.: 19/430,896

(22) Filed: Dec. 23, 2025

(30) Foreign Application Priority Data
Dec. 26, 2024 (JP) 2024-230261

(51) Int. Cl. G02B 6/38

(52) U.S. Cl. CPC G02B 6/387; G02B 6/3881; G02B 6/3885; G02B 6/38875; G02B 6/3893; G02B 6/3895

(57) ABSTRACT

An optical connector includes: a ferrule that has a connection end surface in which fiber holes are formed side by side in a first direction; a biasing member configured to bias the ferrule in a second direction in which the fiber holes extend; a housing configured to accommodate the biasing member and part of the ferrule; a coupling configured to be attached to an outer side of the housing such that the coupling is configured to move in the second direction; and a boot configured to engage with the coupling and configure to move integrally with the coupling. The boot is disposed, as viewed from the second direction, inside an outer contour of the coupling.

### CROSS-REFERENCE TO RELATED APPLICATION

Priority is claimed on Japanese Patent Application No. 2024-230261, filed Dec. 26, 2024, the content of which is incorporated herein by reference.

### TECHNICAL FIELD

The present invention relates to an optical connector.

### BACKGROUND

US11474308B2 discloses a multi-fiber optical connector that connects a plurality of optical fibers. The multi-fiber optical connector includes a ferrule that fixes an end portion of an optical fiber strand, a spring that biases the ferrule forward, a housing that accommodates part of the ferrule and a spring, a sleeve that is slidably attached to an outside of the housing, and a flexible boot that is disposed behind the sleeve.

### SUMMARY

The flexible boot includes a pair of forward extending portions that extend forward and the pair of forward extending portions sandwich the sleeve from above and below. Therefore, the flexible boot is configured larger than the sleeve in a vertical direction, and it is difficult to densely mount a plurality of optical connectors in the vertical direction.

In addition, in a case where the optical connector is densely mounted in this way, there is a problem that it is also difficult to attach and detach the optical connector because space between the optical connectors is narrowed.

One or more embodiments of the present invention provide an optical connector that is capable of being densely mounted and that is easy to attach and detach.

An optical connector according to a first aspect of the present invention includes a ferrule configured to have a connection end surface in which a plurality of fiber holes are formed side by side in a first direction, a biasing member configured to bias the ferrule in a second direction in which the connection end surface is connected; a housing that accommodates part of the ferrule and the biasing member; a coupling configured to be attached to an outer side of the housing to be movable in the second direction; and a boot configured to engage with the coupling and move integrally with the coupling, in which the boot is disposed, as viewed from the second direction, within a range of an outer contour of the coupling.

According to a second aspect of the present invention, in the optical connector according to the first aspect, an engagement groove and a column portion may be provided in the coupling, the engagement groove may be formed on an outer surface of the coupling, the column portion may be disposed in the engagement groove and may be provided at a height equal to or lower than a height of the outer surface, an engagement portion may be provided in a boot, an engagement hole may be formed in the engagement portion and the engagement portion may be accommodated in the engagement groove, and the engagement hole may be engaged with the column portion.

According to a third aspect of the present invention, in the optical connector according to the second aspect, the column portion may have a rectangular prism shape including a side surface portion extending in the first direction in a plan view as viewed from a third direction orthogonal to the first direction and the second direction.

According to a fourth aspect of the present invention, in the optical connector according to any one of the first to third aspects, a trace mark may be formed on a boundary line between the coupling and the boot.

According to a fifth aspect of the present invention, in the optical connector according to any one of the first to fourth aspects, a flat-shaped gripping part extending in the first direction may be provided at a rear end portion of the boot.

According to one aspect of the present invention, it is possible to provide an optical connector which can be densely mounted and is easy to attach and detach.

### BRIEF DESCRIPTION OF THE DRAWINGS

FIG. 1 is a side view showing an attachment state of an optical connector according to one or more embodiments.

FIG. 2 is a front view of the optical connector according to one or more embodiments.

FIG. 3 is a cross-sectional view of the optical connector according to one or more embodiments.

FIG. 4 is a perspective view of the optical connector according to one or more embodiments.

FIG. 5 is an exploded perspective view of the optical connector according to one or more embodiments.

FIG. 6 is a plan view of the optical connector according to one or more embodiments.

### DETAILED DESCRIPTION

Hereinafter, an optical connector of one or more embodiments will be described based on the drawings.

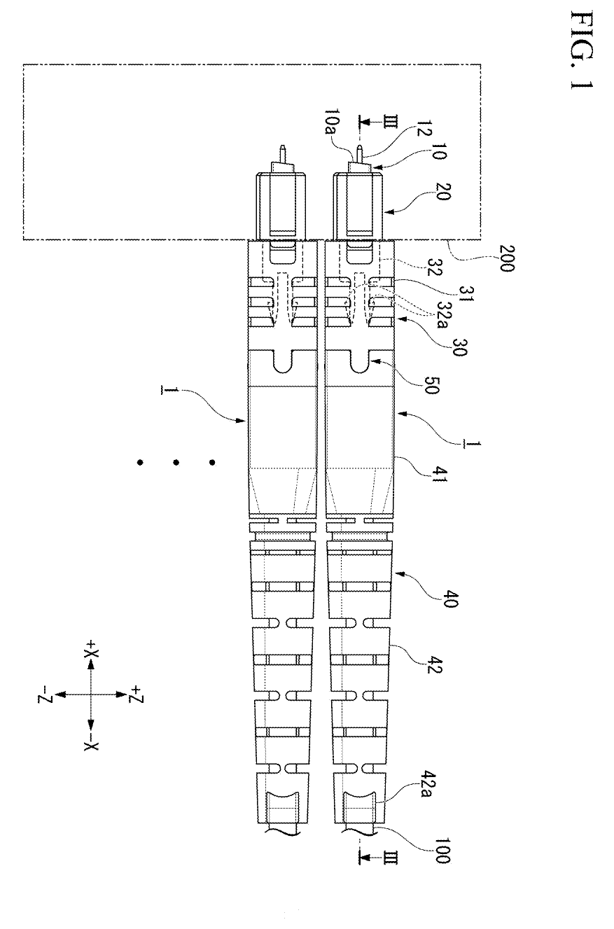

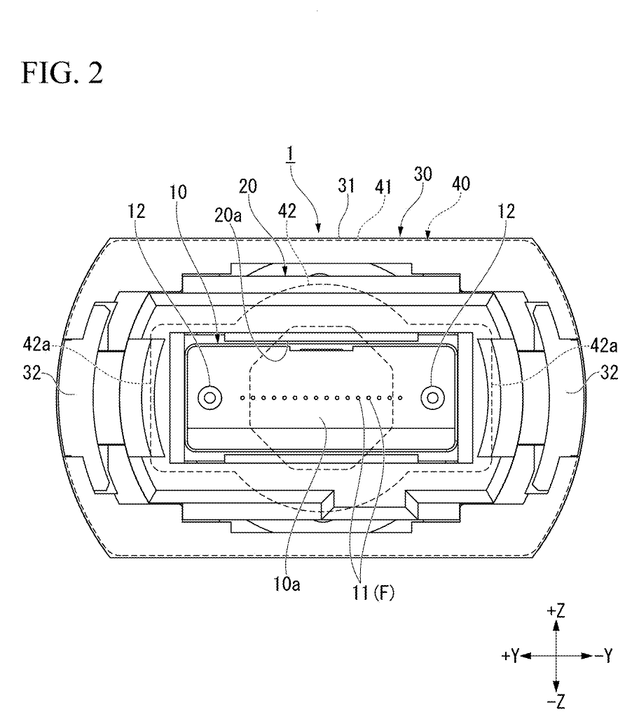

FIG. 1 is a side view showing an attachment state of an optical connector 1 according to one or more embodiments. FIG. 2 is a front view of the optical connector 1 according to one or more embodiments.

As shown in FIG. 1, the optical connector 1 comprises a ferrule 10, a housing 20, a coupling 30, and a boot 40. As shown in FIG. 2, a plurality of fiber holes 11 arranged in a row are formed in the ferrule 10. The plurality of fiber holes 11 may be arranged in two or more rows.

The ferrule 10 has a connection end surface 10a in which the plurality of fiber holes 11 are formed. The fiber hole 11 and a positioning pin 12 are provided in the connection end surface 10a. The optical fiber F is disposed in each of the plurality of fiber holes 11. The optical fiber F may not be disposed in part of the fiber holes 11. That is, the number of optical fibers F may be smaller than the number of fiber holes 11. The optical fiber F is exposed at the connection end surface 10a. The optical connector 1 can be connected to another optical connector by bringing a connection end surface of the other optical connector to be connected into contact with the connection end surface 10a.

In the following description, an XYZ Cartesian coordinate system may be set, and a positional relationship of respective members may be described with reference to the XYZ Cartesian coordinate system. As shown in the drawing, an X-axis direction is set in a connection direction of the optical connector 1 (a direction in which the connection end surface 10a faces, a direction in which the fiber holes 11 extend, and a longitudinal direction of the optical connector 1). In the X-axis direction, a side of the connection end surface 10a (+X side) may be referred to as a front side, and the opposite side (-X side) may be referred to as a rear side.

The Y-axis direction is set in a width direction of the optical connector 1 (a lateral direction of the optical connector 1 and a direction in which the fiber holes 11 are arranged in a single row). In the Y-axis direction, one side (+Y side) may be referred to as a left side, and the other side (-Y side) may be referred to as a right side. The Z-axis direction is set in a height direction of the optical connector 1. In the Z-axis direction, one side (+Z side) may be referred to as an upper side, and the other side (-Z side) may be referred to as a lower side.

As shown in FIG. 2, at least part of the ferrule 10 is accommodated in an opening portion 20a of the housing 20. The ferrule 10 has two positioning pins 12. The positioning pins 12 protrude forward toward the connection end surface 10a. The two positioning pins 12 are disposed spaced apart in the Y-axis direction. The two positioning pins 12 are disposed to interpose a plurality of the fiber holes 11 in the Y-axis direction.

As shown in FIG. 1, the optical connector 1 according to one or more embodiments is connected to a connection adapter 200 and is densely mounted at a minute gap in the Z-axis direction. The optical connector 1 is a male side, and within the connection adapter 200, the positioning pins 12 are inserted into another optical connector on the female side (not shown) having a positioning hole, whereby the relative position of the optical connector 1 and the other optical connector is determined and the optical connector 1 and the other optical connector are connected to each other.

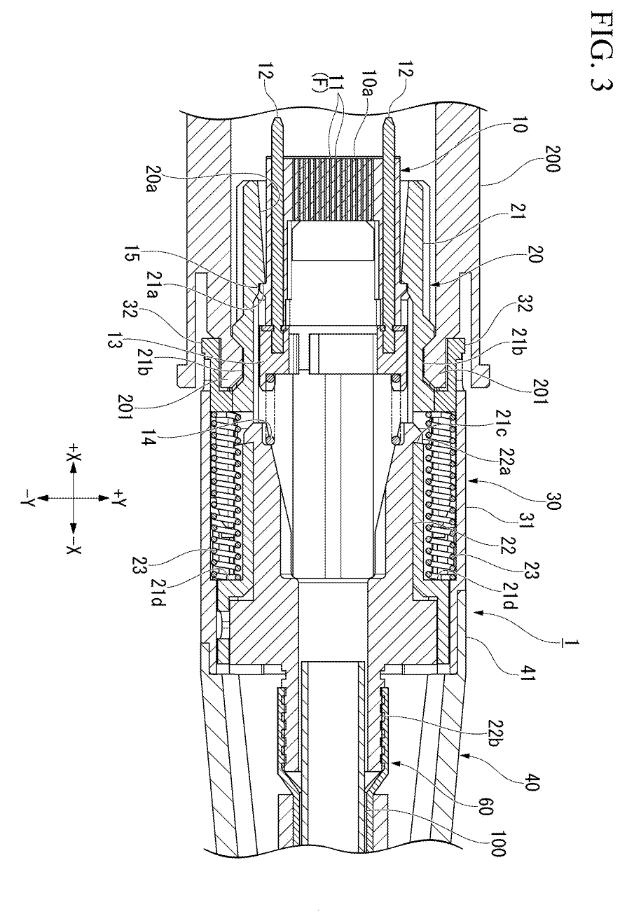

FIG. 3 is a cross-sectional view of the optical connector 1 according to one or more embodiments.

As shown in FIG. 3, the housing 20 includes a front housing 21 and a rear housing 22. The front housing 21 and the rear housing 22 are formed in a substantially rectangular tubular shape as viewed in the X-axis direction. A restriction groove 21a that restricts the ferrule 10 from protruding from the opening portion 20a of the housing 20 is formed on an inner wall surface of the front housing 21. A regulating piece 15 that abuts on the restriction groove 21a from a rear side is formed on an outer wall surface of the ferrule 10.

A locking groove 21b into which the locking piece 201 of the connection adapter 200 is fitted is formed on an outer wall surface of the front housing 21. A fitting hole 21c that penetrates the front housing 21 in the Z-axis direction is formed rearward of the locking groove 21b. A front end portion of the rear housing 22 is inserted into the front housing 21 from a rear side of the front housing 21. A fitting protrusion 22a that is fitted into the fitting hole 21c from the inside of the front housing 21 is formed on the front end portion of the rear housing 22.

A cable jack 22b is provided at a rear end portion of the rear housing 22. A cable socket 60 provided on the optical cable 100 is connected to the cable jack 22b. The pin clamp 13 (intermediate member) and the first biasing member 14 (biasing member) are accommodated inside the housing 20. The optical fiber F (not shown) extends from an end portion of the optical cable 100 in the X-axis direction, passes through the inside of the rear housing 22, the pin clamp 13, and the front housing 21, and is inserted into each fiber hole 11 of the ferrule 10.

The pin clamp 13 is disposed on a rear side (-X side) of the ferrule 10. That is, the pin clamp 13 is disposed on a side of the ferrule 10 opposite to the connecting end surface 10a. The pin clamp 13 is in contact with the rear side of the ferrule 10 and holds the positioning pin 12. The pin clamp 13 has a role of transmitting a biasing force of the first biasing member 14 to the ferrule 10. A front end portion of the first biasing member 14 is in contact with the pin clamp 13, and a rear end portion of the first biasing member 14 is in contact with a spring receiving groove formed inside the rear housing 22.

The coupling 30 comprises an outer coupling 31 and an inner coupling 32. The outer coupling 31 is formed in a substantially rectangular tubular shape as viewed in the X-axis direction. The outer coupling 31 is movably attached to an outside of the housing 20 in the X-axis direction. The inner coupling 32 is disposed in a gap between the outer coupling 31 and the housing 20 and is movable in the X-axis direction between a locked position facing the locking groove 21b and a release position located rearward of the locking groove 21b.

In a gap between the outer coupling 31 and the housing 20, the second biasing member 23 is disposed so as to bias the inner coupling 32 forward (+X side) from the release position toward the locked position. The second biasing member 23 is accommodated in the spring receiving groove 21d formed on the outer wall surface of the front housing 21. As shown by a dotted line in FIG. 1, an L-shaped hook piece 32a is provided at a rear end portion of the inner coupling 32, and movement of the inner coupling 32 toward the +X side with respect to the outer coupling 31 is restricted to a certain range, and movement of the inner coupling 32 toward the -X side with respect to the outer coupling 31 is allowed.

In a case where the optical connector 1 having the above-described configuration is inserted into the connection adapter 200, a locking piece 201 of the connection adapter 200 shown in FIG. 3 pushes the inner coupling 32 toward the -X side. As a result, the inner coupling 32 moves from the locked position to the release position against the biasing force of the second biasing member 23. In a case where the inner coupling 32 moves to the release position, the locking groove 21b is opened, and the locking piece 201 is fitted to the locking groove 21b.

In a case where the locking piece 201 is fitted to the locking groove 21b, the inner coupling 32 is moved from the release position to the locked position by the biasing force of the second biasing member 23, and the release of the locking piece 201 from the locking groove 21b is restricted.

As described above, the optical connector 1 can be attached to the connection adapter 200.

In a case where the optical connector 1 is removed from the connection adapter 200, the outer coupling 31 is pulled toward the -X side by pinching the boot 40 described later. In this case, the inner coupling 32 that is hooked on the outer coupling 31 via the hook piece 32a moves toward the -X side together with the outer coupling 31. As a result, the inner coupling 32 is moved from the locked position to the release position, the locking groove 21b is opened, and the locking piece 201 can be released.

As described above, the optical connector 1 can be removed from the connection adapter 200.

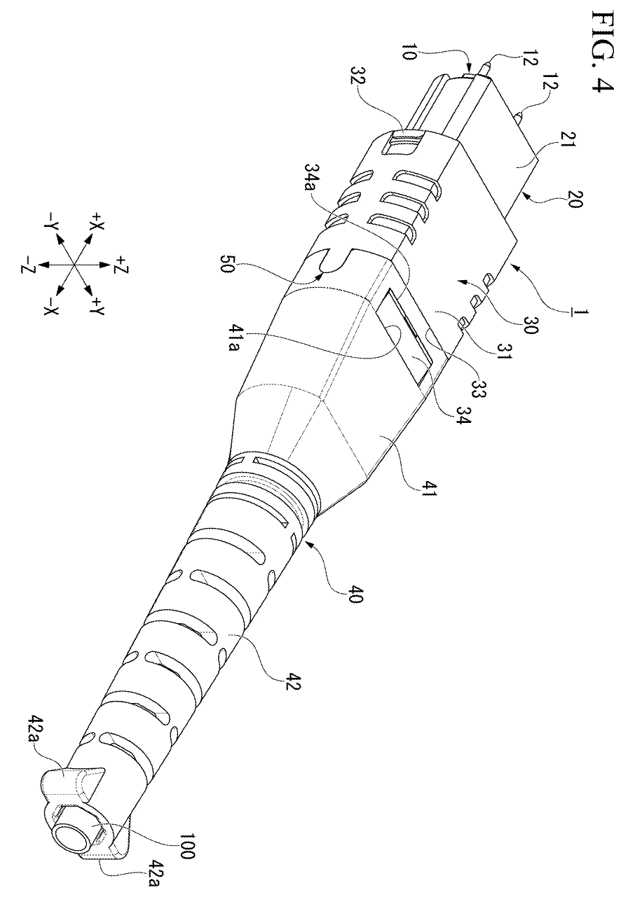

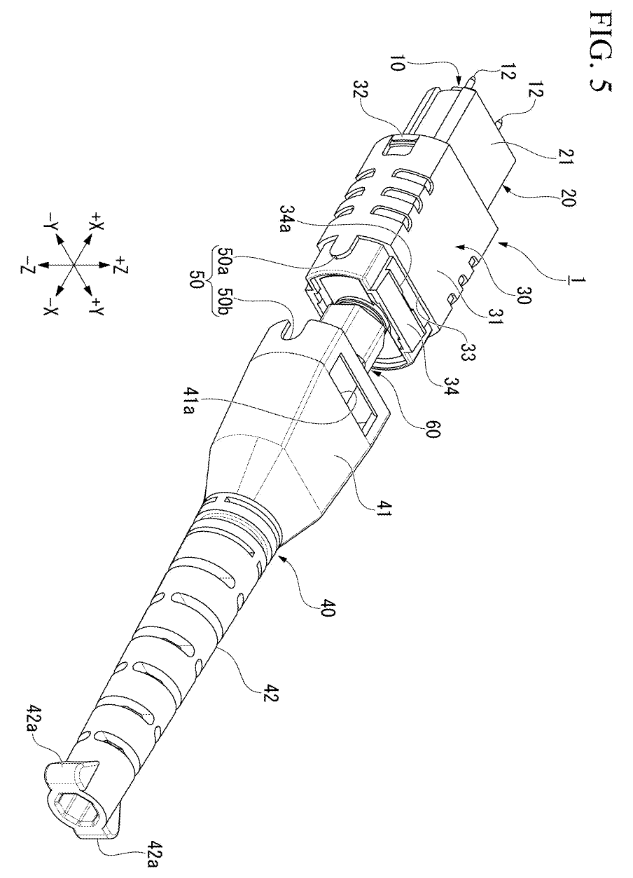

FIG. 4 is a perspective view of an optical connector according to one or more embodiments. FIG. 5 is an exploded perspective view of the optical connector 1 according to one or more embodiments.

As shown in these figures, the optical connector 1 comprises a boot 40 that is engaged with the outer coupling 31. The boot 40 is integrally formed with the outer coupling 31 and is movable in the X-axis direction.

The boot 40 comprises an engaging part 41 that is engaged with the outer coupling 31 and a tail part 42 that extends rearward from the engagement portion 41. The engagement portion 41 is provided at a front end portion of the boot 40. The engagement portion 41 is formed in a rectangular tubular shape that opens toward the +X side. An outer surface of the engagement portion 41 is continuous with an outer surface of the outer coupling 31. A rear portion of the engagement portion 41 is configured that an outer shape of the rear portion of the engagement portion 41 becomes smaller in a tapered shape toward the -X side. The rear portion of the engagement portion 41 is formed continuously with a front end of the tail part 42.

As shown in FIG. 5, the outer coupling 31 is provided with an engagement groove 33 formed on the outer surface of the outer coupling 31 and a column portion 34 that is disposed in the engagement groove 33 and is provided at a height equal to or lower than the outer surface of the outer coupling 31. The engagement groove 33 is formed on the entire periphery of the rear portion of the outer coupling 31 and accommodates the engagement portion 41 of the boot 40. A depth of the engagement groove 33 may be equal to or greater than a thickness of the engagement portion 41. As a result, the engagement portion 41 does not protrude outward from the outer shape of the outer coupling 31.

The column portion 34 has a rectangular prism shape that includes a side surface portion 34a that extends in the Y-axis direction in a plan view as viewed from the Z-axis direction (third direction). Specifically, the column portion 34 has a rectangular prism shape that is long in the Y-axis direction and short in the X-axis direction. In the engagement portion 41, an engagement hole 41a having a rectangular shape in the plan view is formed to engage with the column portion 34. It should be noted that the column portion 34 is provided on each of an upper surface of the outer coupling 31 on the +Z side and a lower surface of the outer coupling 31 on the -Z side. In the engagement portion 41, two engagement holes 41a are also formed corresponding to the column portion 34.

As shown in FIG. 4, a trace mark 50 is formed at a boundary line between the outer coupling 31 and the boot 40. The trace mark 50 is formed only on the +X side of the optical connector 1. As a result, the left-right orientation of the optical connector 1 can be specified. As shown in FIG. 5, the trace mark 50 is formed in a substantially U-shape by engaging a protrusion portion 50a provided on the outer coupling 31 with a recess portion 50b provided on the boot 40.

A tail part 42 of the boot 40 is formed in a cylindrical shape. A plurality of arc-shaped slits are formed in the tail part 42, so that the tail part 42 can be elastically deformed flexibly. A flat gripping part 42a that extends in the Y-axis direction is provided at a rear end portion of the tail part 42. A dimension of the gripping part 42a in the Z-axis direction is set smaller than a dimension of the rear end portion of the tail part 42 in the Z-axis direction. The gripping part 42a extends from the rear end portion of the tail part 42 to both sides in the Y-axis direction, and has a substantially isosceles triangular shape as viewed in the Z-axis direction.

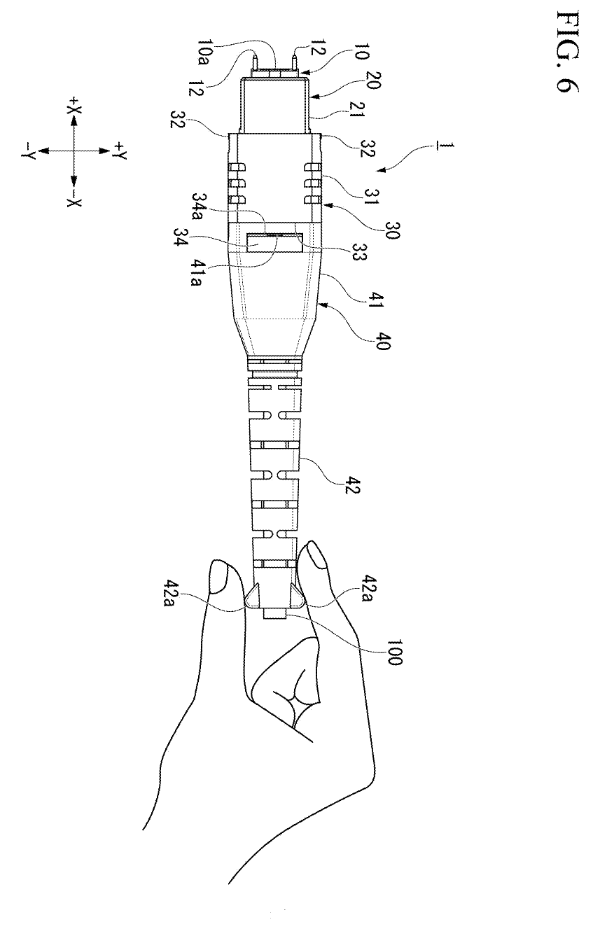

FIG. 6 is a plan view of the optical connector 1 according to one or more embodiments.

As shown in FIG. 6, with the optical cable 100 having the above-described configuration, the coupling 30 can be operated from a position away from the housing 20 by gripping the gripping part 42a of the rear end portion of the boot 40. Therefore, even in a case where the optical connector 1 is densely mounted as shown in FIG. 1, the optical connector 1 can be easily attached to and detached from the connection adapter 200. In addition, since the gripping part 42a has a flat shape extending in the Y-axis direction, a gap in the Z-axis direction can be secured to be large, so that the optical connector 1 alone can be gripped and attached to and detached from.

As described above, the optical connector 1 according to one or more embodiments includes a ferrule 10 that has a connection end surface 10a in which a plurality of fiber holes 11 are formed in a row in the Y-axis direction (first direction), a first biasing member 14 (biasing member) that biases the ferrule 10 in the X-axis direction (second direction) in which the connection end surface 10a is connected, a housing 20 that accommodates part of the ferrule 10 and the first biasing member 14, a coupling 30 that is attached to an outside of the housing 20 to be movable in the X-axis direction, and a boot 40 that engages with the coupling 30 and moves integrally with the coupling 30.

As shown in FIG. 2, the boot 40 is disposed within a range of an outer shape contour of the coupling 30 (outer coupling 31) as viewed in the X-axis direction. According to this configuration, since the outer shape of the boot 40 is smaller than the outer shape of the coupling 30, for example, as shown in FIG. 1, a plurality of optical connectors 1 can be densely mounted in the Z-axis direction. In addition, since the optical connector 1 can be attached to and detached from by gripping the boot 40 and operating the coupling 30, the optical connector 1 can be easily attached to and detached from even in a case where the optical connector 1 is densely mounted.

In addition, in one or more embodiments, the coupling 30 is provided with the engagement groove 33 formed on an outer surface of the outer coupling 31 and the column portion 34 that is disposed in the engagement groove 33 and is provided at a height equal to or lower than the outer surface of the outer coupling 31, and the boot 40 is provided with the engagement portion 41 that is provided with the engagement hole 41a that engages with the column portion 34 and is accommodated in the engagement groove 33. According to this configuration, the coupling 30 and the boot 40 can be engaged without causing the boot 40 to protrude from the outer surface of the coupling 30.

In addition, in one or more embodiments, the column portion 34 has a shape of a rectangular prism including the side surface portion 34a that extends in the Y-axis direction in a plan view as viewed in the Z-axis direction (third direction) orthogonal to the X-axis direction and the Y-axis direction. According to this configuration, in a case where the boot 40 is pulled to the -X side, the engagement hole 41a comes into contact with the side surface portion 34a of the column portion 34 over a large area, so that stress concentration on the engagement hole 41a can be alleviated.

In addition, in one or more embodiments, the trace mark 50 is formed on a boundary line between the coupling 30 and the boot 40. According to this configuration, the left-right orientation of the optical connector 1 can be specified without performing marking or the like on the optical connector 1.

In addition, in one or more embodiments, the boot 40 is provided with a flat-shaped gripping part 42a that extends in the Y-axis direction. According to this configuration, as shown in FIG. 1, even in a case where the optical connector 1 is densely mounted in the Z-axis direction, a gap in the Z-axis direction can be ensured, so that only the target optical connector 1 can be attached and detached.

While one or more embodiments of the present invention have been described and illustrated above, it should be understood that these are exemplary of the present invention and should not be considered as limiting. Additions, omissions, substitutions, and other modifications can be made without departing from the scope of the present invention. Accordingly, the present invention should not be considered as being limited by the foregoing description, and is only limited by the scope of the appended claims.

For example, in the above-described embodiments, the configuration in which the coupling 30 includes the outer coupling 31 and the inner coupling 32 has been described, but the present invention is not limited to this configuration. The coupling 30 may be formed of one component, for example, as in a sleeve of a related art.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An optical connector comprising:
a ferrule that has a connection end surface in which fiber holes are formed side by side in a first direction;
a biasing member configured to bias the ferrule in a second direction in which the fiber holes extend;
a housing configured to accommodate the biasing member and part of the ferrule;
a coupling configured to be attached to an outer side of the housing such that the coupling is configured to move in the second direction; and
a boot configured to engage with the coupling and configure to move integrally with the coupling, wherein
the boot is disposed, as viewed from the second direction, inside an outer contour of the coupling.

2. The optical connector according to claim 1, wherein
the coupling comprises:
an engagement groove on an outer surface of the coupling; and
a column portion in the engagement groove at a height equal to or lower than a height of the outer surface,
the boot comprises an engagement portion that has an engagement hole,
the engagement portion is accommodated in the engagement groove, and
the engagement hole engages with the column portion.

3. The optical connector according to claim 2, wherein the column portion has a rectangular prism shape including a side surface portion extending in the first direction in a plan view as viewed from a third direction orthogonal to the first direction and the second direction.

4. The optical connector according to claim 1, wherein a trace mark is disposed on a boundary line between the coupling and the boot.

5. The optical connector according to claim 1, wherein a flat-shaped gripping part extending in the first direction is disposed at a rear end portion of the boot.

6. The optical connector according to claim 2, wherein a trace mark is disposed on a boundary line between the coupling and the boot.

7. The optical connector according to claim 3, wherein a trace mark is disposed on a boundary line between the coupling and the boot.

8. The optical connector according to claim 2, wherein a flat-shaped gripping part extending in the first direction is disposed at a rear end portion of the boot.

9. The optical connector according to claim 3, wherein a flat-shaped gripping part extending in the first direction is disposed at a rear end portion of the boot.
